(19) United States
(12) Patent Application Publication
(10) Pub. No.: US 2016/0129451 A1
(43) Pub. Date: May 12, 2016

(54) HSI ROTOR POSITIONING DEVICE

(71) Applicant: SANDVIK INTELLECTUAL PROPERTY AB, Sandviken (SE)

(72) Inventors: Rowan DALLIMORE, Bath (GB); Andreas FORSBERG, Malmo (SE); Knut KJAERRAN, Svedala (SE)

(21) Appl. No.: 14/938,012

(22) Filed: Nov. 11, 2015

(30) Foreign Application Priority Data
Nov. 12, 2014 (EP) PCT/EP2014/074342

(51) Int. Cl. B02C 13/26; B02C 13/09

(52) U.S. Cl. CPC B02C 13/26; B02C 13/09; B02C 2013/29

(57) ABSTRACT

A rotor positioning device adjusts a rotational position of a rotor of a horizontal shaft impact crusher. The device is mountable to an external region of a main frame of a crusher so as to releasably couple to an exposed end of a main shaft of the rotor. The device includes a shaft engager capable of being moved to and from engaging contact with the rotor shaft end. A drive component provides rotational drive of the rod to impart rotational adjustment of the position of the rotor shaft.

### RELATED APPLICATION DATA

This application claims priority under 35 U.S.C. §119 to PCT/EP2014/074342, filed on Nov. 12, 2014, which the entirety thereof is incorporated herein by reference.

### TECHNICAL FIELD

The present disclosure relates to a rotor positioning device to adjust the rotational position of a rotor of a horizontal shaft impact crusher, the positioning device mountable to an external region of the crusher and having a rotationally driven shaft engager to impart rotational drive to the rotor shaft.

### BACKGROUND

Horizontal shaft impact crushers (HSi crushers) are utilized in many applications for crushing hard material, such as pieces of rock, ore etc. A HSi crusher includes a crushing chamber housing an impeller (alternatively termed a rotor) that is driven to rotate about a horizontal axis. Pieces of rock are fed towards the impeller and are struck by impeller mounted hammer elements. The rock pieces are disintegrated initially by striking contact with the hammer elements and are then accelerated and thrown against breaker plates (typically referred to as curtains) to provide further disintegration. The action of the impeller causes the material fed to the horizontal shaft impact crusher to move freely in the chamber and to be crushed upon impact against the hammer elements, against the curtains, and against other pieces of material moving around at high speed within the chamber. Example of HSi crushers are described in WO 2010/071550; WO 2011/129744; WO 2011/129742; WO 2013/189691 and WO 2013/189687.

As will be appreciated, the hammer wear parts require regular maintenance and replacement. Hammer replacement necessitates rotational adjustment of the rotor once the crusher has stopped to position one of the rotor hammer rows to top dead-center so that the worn hammers can be removed and replacement elements inserted. Additionally, the separation distance between the hammer row and a toe of the curtain requires both an initial calibration and periodic adjustment to achieve and maintain a desired particle size distribution. Again, this requires personnel to rotational adjust the position of the rotor.

Conventionally, the impact rotor is adjusted manually by an operator leaning into the crushing chamber and manually turning the rotor by hand. This form of adjustment poses significant health and safety risks to service personnel. In an attempt to address this, US 2013/0284839 describes an impact mill having a rotor positioning device mounted internally within the crusher comprising a driven indexing component that provides rotation of the rotor (and in particular the hammer rows) when the crusher is inoperative.

However, the integral powered positioning device of US 2013/0284839 is disadvantageous for a number of reasons. In particular, such a device adds weight to the crusher which is undesirable for transportation and installation. Additionally, the device increases the complexity of the crusher internal construction and introduces additional servicing and maintenance problems with access being required to the internally mounted device when components wear or the device malfunctions. Accordingly, what is required is a rotor positioning device that addresses these problems.

### SUMMARY

The device of the present disclosure facilitates the rotational positioning of a rotor of a horizontal shaft impact (HSi) crusher that is capable of being mounted at and decoupled from an external region of the crusher so as to be connected only when required. More specifically, to provide a rotor positioning device that is compatible with a variety of different HSi crushers and requires no or little modification to the crusher and in particular to the internal components associated with the shaft of the rotor.

Furthermore, a rotor positioning device can be retro-fitted to existing HSi crushers to enable operating personnel to manually adjust the rotational position of the rotor via an external region of the crusher.

The above is achieved via a rotor positioning device mountable at an external region of the crusher mainframe at a location close to or adjacent the non-driven end of the rotor shaft to releasably engage the rotor shaft end and impart rotational drive to the shaft. The present device is advantageous to maintain to a minimum the overall weight of the crusher during transportation and installation by being demountably connectable to an external region of the crusher frame via at least one releasable mounting. In one aspect, the present device may be releasably bolted to an external region of the crusher frame such that a rotatable rod of the device is positionable coaxially with the rotor shaft. Moreover, a drive component of the device is configured to impart rotation of the shaft via the rod and an intermediate shaft engager provided at one end of the rod. The present device avoids the need for personnel to access the crushing chamber when changing rotor hammers or the curtain setting which typically involves rotation of the rotor to a desired orientation.

According to a first aspect of the present disclosure there is provided a rotor positioning device to adjust a rotational position of a rotor of a horizontal shaft impact crusher, the positioning device comprising: a frame; at least one mounting provided at the frame to releasably mount the device at an external region of the crusher; a rod rotatably mounted at the frame; a shaft engager provided at one end of the rod to engage and end of the shaft of the rotor so as to rotatably lock the rod and the shaft; the shaft engager being adjustably mounted relative to at least a part of the frame to enable the engager to move to and from contact with the shaft of the rotor when the frame is mounted at the crusher; and a drive component coupled to the rod to rotate the engager and impart rotational drive to the shaft of the rotor.

The device further includes a bearing assembly mounting the rod at the frame, the bearing assembly allowing the rod to slide axially relative to the frame and to move the engager to and from contact with the shaft of the rotor. The bearing assembly may have a single or multiple bearing assemblies mounted at different axial positions relative to the rod. The bearing assembly can be mounted within a drive transmission assembly or gearbox supported at the mainframe and is substantially stationary relative to the frame so as to support the axial sliding and rotational movement of the rod.

A second end of the rod projects rearwardly beyond the frame so as to be exposed relative to a second side of the frame, the shaft engager extending from a first side of the frame. Such an arrangement allows personnel to grasp the rod to actuate the axial sliding movement by pushing and pulling the engager towards and away from contact with the rotor shaft end.

Optionally, the shaft engager includes a disk and a plurality of keying elements projecting from the disk configured to be received within an end of the shaft of the rotor. The keying elements may include plugs projecting from a first side of the disk, the rod projecting from a second side of the disk. The plugs can also be formed as short cylindrical stubs circumferentially spaced apart at the disk and mounted at the same radial position. For example, the device can have three plugs of the same axial length projecting from one side of the disk.

Optionally, the at least one mounting includes a plurality of holes provided at the frame to receive attachment bolts to mount the device to the region of the crusher. Optionally, the device further includes a plurality of bolts to be received within the holes and configured to engage respective holes provided at the region of the crusher to which the device is mountable. Alternatively, the device may have any form of mounting and attachment bracket suitable for the releasable attachment or clamping onto the crusher frame adjacent the end of the rotor shaft. Optional mountings may include screws, pins, lugs bayonet fixings, clamping devices, threaded engagers, hooked members, tongue and groove arrangements, locking pins and the like.

Optionally, the frame includes a base frame carrying the at least one mounting. The base frame can project downwardly from a main section of the frame and have an abutment end to contact the region of the crusher to which the device is mountable. A lower region of the base frame may include a mounting bracket configured to clamp or be clamped onto the crusher frame at a location below the rotor shaft. The mounting bracket positioned vertically below the rod, is advantageous to contact a lower region of the crusher frame so as to support the rod and shaft engager at an elevated mounting position to allow the rod to be coaxially aligned with the rotor shaft. Optionally, the base frame is adjustably mounted at the main section to allow adjustment of the shaft engager relative to the rotor shaft in the vertical and horizontal planes. Optionally, the mounting bracket may be adjustably mounted at the base frame to enable the adjustment of the shaft engager relative to the rotor shaft in the vertical and horizontal planes.

Optionally, the shaft engager is adjustably mounted at the frame and capable of movement in a first lateral sideways direction and a second up and down direction relative to the frame and more specifically the rotor shaft when the device is mounted in position at the crusher. The means by which the shaft engager is adjustable in the horizontal plane may be equally configured to provide adjustment in the vertical plane. Such an arrangement allows convenient attachment of the positioning device to different HSi crushers and to allow convenient fine adjustment of the position of shaft engager to be aligned appropriately with the end of the rotor shaft.

The device can further include a gearbox, the crank handle being rotatably coupled to drive rotation of the rod via the gearbox. For example, the gearbox is a reduction gearbox and can have an overall gear ratio of, for example, 20:1. The gearbox may have any form of power transmission system operative between the drive component and the rod. Optionally, the transmission may have a plurality of gear settings a fly wheel and/or a clutch to provide variable speed transmission. The gearbox can be configured for transmission in both forward and reverse directions. According to further specific implementations, the gearbox may include gear and/or belt transmission components to selectively adjust the speed and/or torque applied to the driven rod from the drive component.

Optionally, the drive component includes a crank handle coupled to the gearbox, the crank handle including an arm and a handle. Preferably, the crank is detachably mounted at the gearbox via a mounting boss provided at one end of an axel to facilitate transportation and storage of a device between operation. Alternatively, the drive component may have an electric, hydraulic or pneumatic motor mounted at or remote from the positioning device. The motor may be controlled locally or remotely via wired or wireless communications and suitable electronic control implementing control software.

According to a second aspect of the present disclosure there is provided a horizontal shaft impact crusher including a detachable rotor positioning device releasably mounted at an external region of the crusher.

According to a further aspect of the present disclosure there is provided a method of driving rotation of a rotor of a horizontal shaft impact crusher via the mounting at an external position of the crusher a rotor positioning device as described herein, comprising the steps of moving a shaft engager into engaging contact with an exposed end face of the rotor shaft and rotating the shaft engager via a rod and at least one drive component coupled to the rod to impart rotational drive to the shaft of the rotor of the crusher.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF DRAWINGS

FIG. 1 is cross-sectional side view of a horizontal shaft impact crusher having an internally mounted rotor mounted on a rotor shaft that carries a plurality of replaceable hammer elements according to a specific implementation of the present disclosure.

FIG. 2 is a perspective view of the rotor positioning device releasably mountable to an external side of the frame of the crusher of FIG. 1.

FIG. 3 is a side view of the positioning device of FIG. 2.

FIG. 4 is a perspective view of the positioning device of FIG. 3 mounted at the external region of the crusher of FIG. 1.

FIG. 5 is a further perspective view of the positioning device of FIG. 4 mounted at the crusher of FIG. 1 being disengage from the rotor shaft.

### DETAILED DESCRIPTION

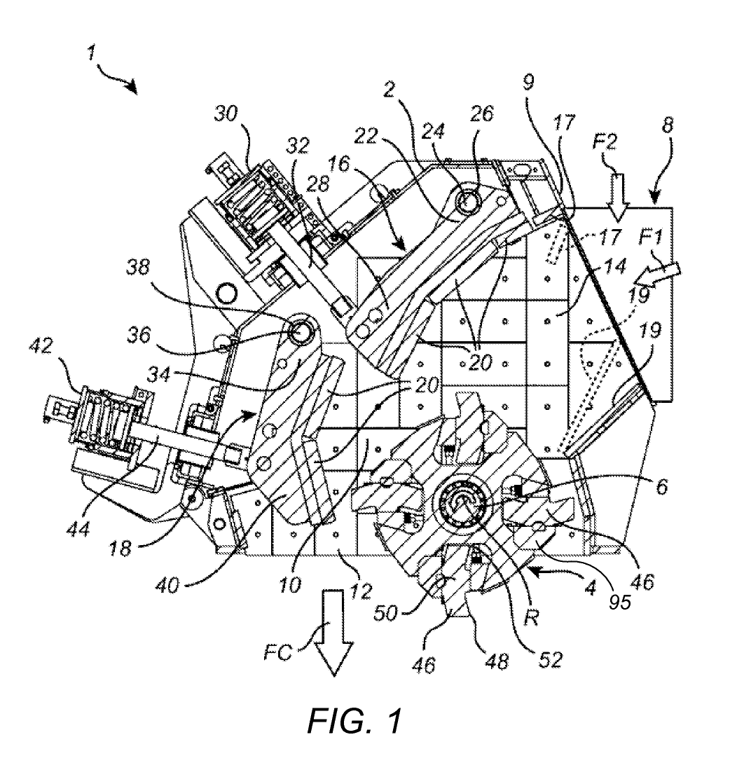

Referring to FIG. 1, a horizontal shaft impact crusher 1 (HSi crusher) includes a housing 2 in which an impeller indicated generally by reference 4 is rotatably mounted. A motor, (not illustrated) is operative for rotating a horizontal shaft 6 on which the impeller 4 is mounted. As an alternative to impeller 4 being fixed to shaft 6, impeller 4 may rotate around shaft 6. In either case, impeller 4 is operative for rotating around a horizontal axis, coaxial with the centre of shaft 6.

Material to be crushed is fed to a feed chute 8, which is mounted to an inlet flange 9 of housing 2, and enters a crushing chamber 10 positioned inside the housing 2 and at least partly enclosing impeller 4. Material crushed within the crusher 1 exits the crushing chamber 10 via a crushed material outlet 12. Housing 2 is provided with a plurality of interior wear protection plates 14 operative for protecting the interior of crushing chamber 10 from abrasion and impact by the material to be crushed.

Crusher 1 includes a first curtain 16, and a second curtain 18 arranged inside crushing chamber 10. Each curtain 16, 18 include at least one wear plate 20 against which material may be crushed. A first end 22 of first curtain 16 is mounted via a horizontal first pivot shaft 24 extending through an opening 26 formed in curtain 16 at the first end 22. First pivot shaft 24 extends further through openings in the housing 2 to suspend the first end 22 in the housing 2. A second end 28 of first curtain 16 is connected to a first adjustment device 30 comprising at least one adjustment bar 32. A first end 34 of second curtain 18 is mounted by means of a horizontal second pivot shaft 36 extending through an opening 38 formed in curtain 18 at first end 34. Second pivot shaft 36 extends further through openings in the housing 2 to suspend the first end 34 in the housing 2. A second end 40 of second curtain 18 is similarly connected to a second adjustment device 42 comprising at least one adjustment bar 44.

Impeller 4 is provided with four hammer elements 46 according to the specific embodiment, with each element 46 having a generally curved shape profile, when viewed in cross-section. An arrow R indicates the rotational direction of impeller 4. A leading edge 48 of each respective hammer element 46 extends in the direction of rotation R. Prior to extended use, hammer element 46 is symmetric around a central portion 50. However, once leading edge 48 has been worn element 46 can be turned and mounted with its second leading edge 52 operative for crushing material.

The HSi crusher 1 can be adjusted to a first crushing setting, which for example may be a primary crushing setting, for crushing large objects (typically having a maximum particle size of 300-1200 mm), and a second (or secondary) crushing setting being different from the first setting for crushing intermediate size objects (having a maximum particle size of less than 400 mm and typically 20-400 mm). When crusher 1 is operated in the primary setting the crushed material exiting crusher 1 via the outlet 12 would typically have an average particle size of 35-300 mm, and typically at least 75% by weight of the crushed material would have a particle size of 20 mm or larger. When crusher 1 is operated in the secondary setting the crushed material leaving the crusher 1 via the outlet 12 would typically have an average particle size of 5 to 100 mm, and typically at least 75% by weight of the crushed material would have a particle size of 5 mm or larger. Within the present specification the ‘average particle size’ refers to weight based average particle size.

Adjusting crusher 1 to the primary crushing setting would typically involve retracting the first and/or second curtains 16, 18 away from impeller 4, to form a crushing chamber 10 having a large volume and a large distance between the impeller 4 and the wear plates 20 of curtains 16, 18. Such retraction of at least one curtain 16, 18 would be performed by operating the first and/or second adjustment devices 30, 42, which may typically involve hydraulic cylinders and/or mechanical adjustment devices using threaded bars. Adjusting the crusher 1 to the secondary crushing setting would, on the other hand, typically involve moving the first and/or second curtains 16, 18 towards the impeller 4 by means of operating the first and/or second adjustment devices 30, 42, to create a crushing chamber 10 having a small volume and a short distance between the impeller 4 and the wear curtain plates 20. In addition to adjusting the position of the curtains 16, 18, the horizontal shaft impact crusher feed chute 8 is adjusted to feed the material into the crushing chamber 10 in a first direction F1 when crusher 1 is adjusted to the primary setting, and in a second direction F2 when crusher 1 is adjusted to the secondary setting. Hence, the first crushing setting is different from the second crushing setting. Furthermore, the first direction F1 of feeding material to the crusher 1 is different from the second direction F2 of feeding material to the crusher 1.

The adjustment of the HSi crusher 1 from a primary crushing setting to a secondary crushing setting may also involve adjusting the positions of an upper feed plate 17 and a lower feed plate 19 that are located just inside of the inlet flange 9 of the housing 2 of the crusher 1. The feed plates 17, 19 protect the inlet of the housing 2, and provide the material fed to housing 2 with a desired direction. In FIG. 1, the upper and lower feed plates 17, 19 are adjusted to the primary setting (shown in unbroken lines) with the intention of directing the coarse material towards impeller 4 and the first curtain 16 when the crusher 1 operates in the primary setting. The positions of the upper and lower feed plates 17, 19 in the secondary setting are indicated with broken lines in FIG. 1. As can be seen the upper and lower feed plates 17, 19 are, in the secondary setting, arranged for directing the material directly towards the impeller 4. In this manner, the rather fine material fed when the crusher 1 operates in the secondary setting will receive more ‘hits’ from the impeller hammer elements 46 leading to a greater reduction in the size of the material.

In operation, material to be crushed is fed to the feed chute 8 and further into the crushing chamber 10, either in the direction F1 if the crusher 1 is adjusted to the primary setting or in the direction F2 if crusher 1 is adjusted to the secondary setting. The material will first reach that part of the crushing chamber 10 which is located adjacent to first curtain 16, being located upstream of the second curtain 18 as seen with respect to the direction of travel of the material. Impeller 4 is rotated at, for example, 400-850 rpm. When the material is impacted by the impeller elements 46 it will be crushed and accelerated against wear plates 20 of first curtain 16 where subsequent and further crushing occurs. The material will bounce back from first curtain 16 and will be crushed further against material travelling in the opposite direction and then again against the elements 46. When the material has been crushed to a sufficiently small size it will move further down the crushing chamber 10, and will be accelerated, by means of the elements 46, towards wear plates 20 of the second curtain 18, being located downstream of first curtain 16. When the material has been crushed to a sufficiently small size it exits chamber 10 via outlet 12 as a flow of crushed material FC.

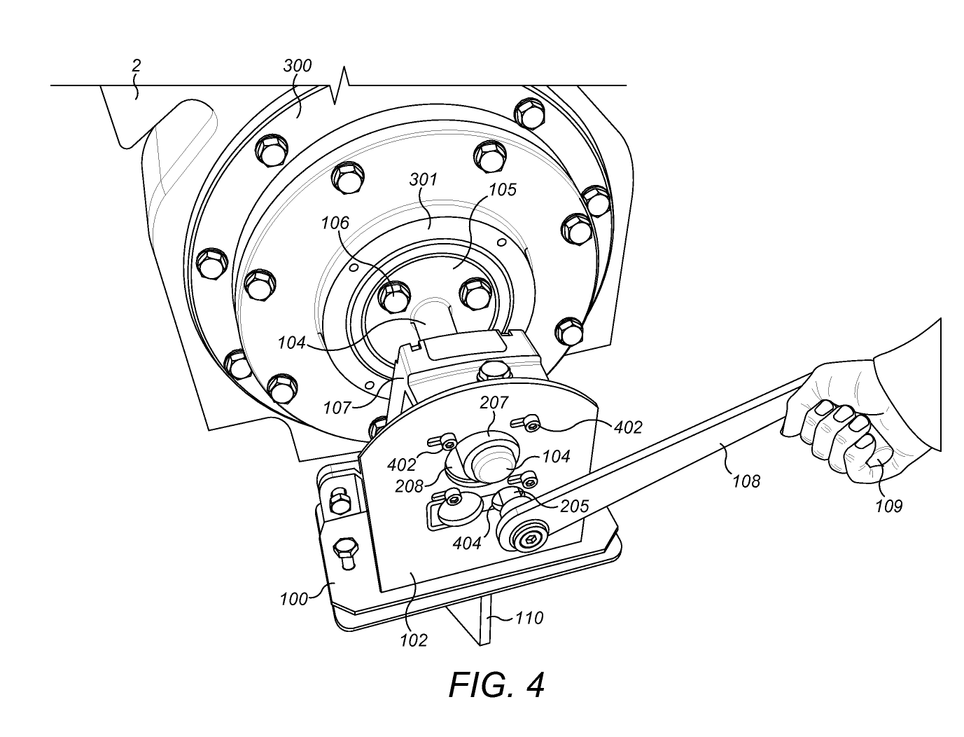

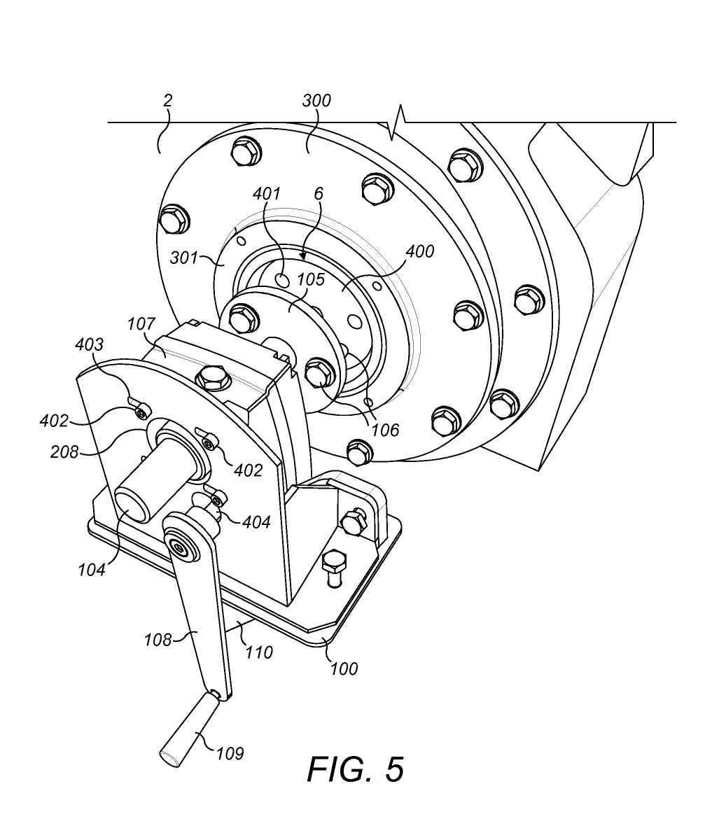

A rotor positioning device 113 is configured to be mounted at an external side of crusher frame 2 adjacent to a non-driven end of rotor shaft 6. Positioning device 113 includes a frame indicated generally by reference 100. Frame 100 includes frame part 114 aligned to be generally horizontal when device 113 is mounted in position adjacent the end of rotor shaft 6 as illustrated in FIGS. 4 and 5. A first frame part 102 is formed as a plate like body extending generally perpendicular to frame part 114 so as to be aligned generally vertically when device 113 is mounted in use at crusher frame 2. Plate like body 102 includes an aperture 208 through which a drive rod 104 extends being aligned generally perpendicular to first frame part 102 and intended to be orientated substantially horizontally and coaxial with rotor shaft 6. Frame 100 further includes a base part 110 extending downwardly from frame part 114 that mounts an attachment bracket 111 positioned towards a lowermost end region 115 of base part 110. Bracket 111 includes three holes 103 arranged generally above and below one another in a vertical direction to receive respectively three attachment bolts 112 used to releasably mount device 113 at crusher frame 2 as illustrated in FIGS. 4 and 5. Bracket 111 is configured for attachment to a lower region of crusher frame 2 such that upwardly extending base frame 110 is configured to position rod 104 coaxial with shaft 6. Accordingly, bracket 111 is mounted at frame 2 vertically below rotor shaft 6. Frame part 102 is stabilised by frame extensions 101a and 101b that are, in turn, rigidly mounted to frame part 114 so as to extend vertically upright from frame part 114.

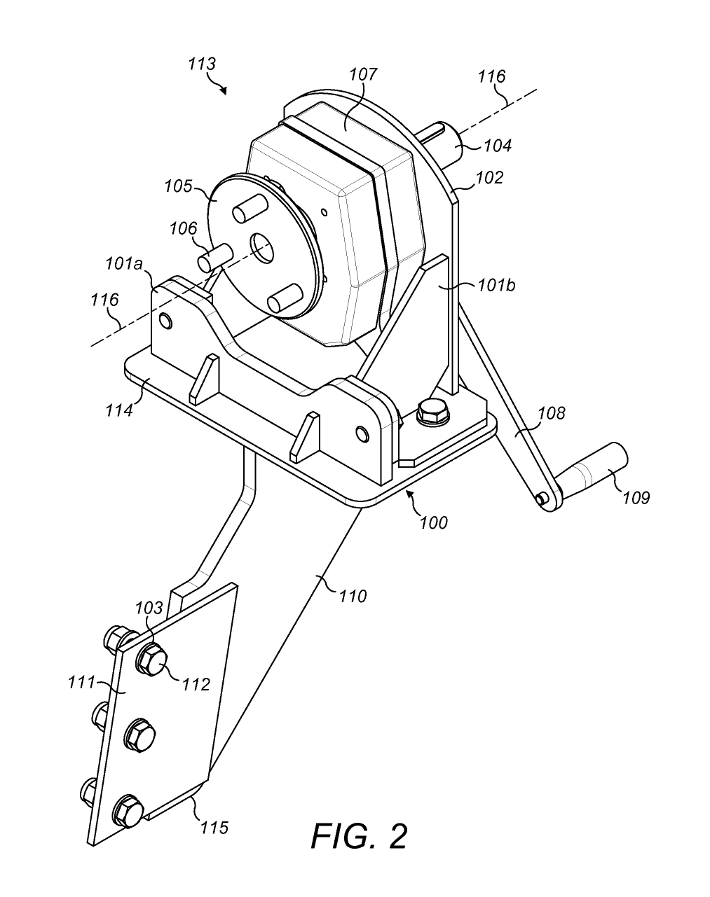

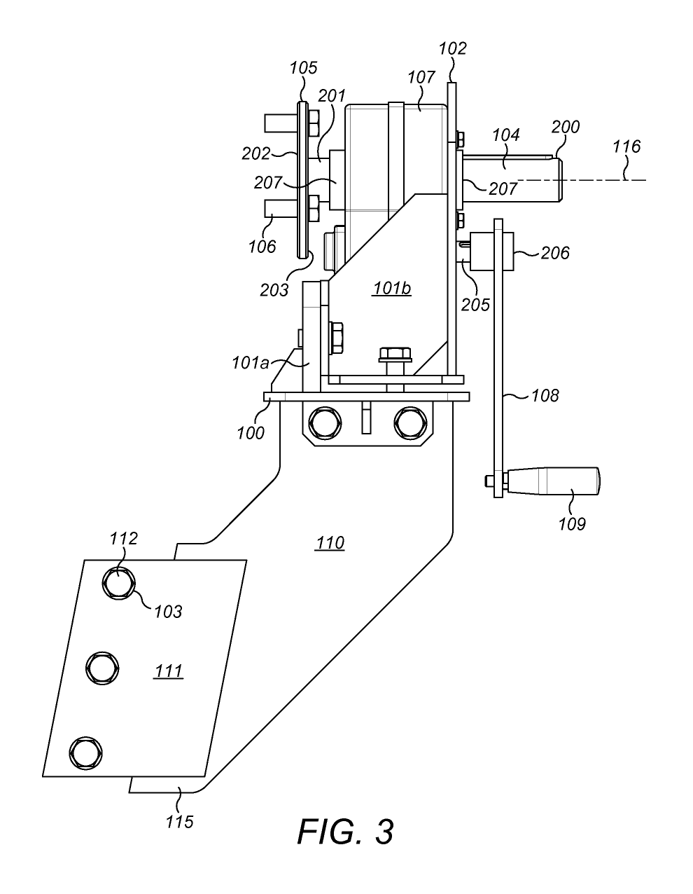

A gearbox indicated generally by reference 107 is movably mounted at frame part 102 via attachment screws 402 received within elongate slots 403 provided within frame part 102. Accordingly, gearbox 107 is capable of sliding laterally in a horizontal plane relative to frame part 114 and in particular base frame 110. Additionally, aperture 208 is oversized relative to rod 104 to allow rod 104 to move in the horizontal (and also the vertical) plane so as to coaxially align rod 104 with crusher shaft 6. Rod 104 is rotatably mounted to extend through gearbox 107 via a bearing assembly indicated generally by reference 207. Bearing assembly 207 is configured to allow rod 104 to rotate about its longitudinal axis 116 and also to enable rod 104 to slide axially (along axis 116) relative to frame part 102 and bearing assembly 207. As illustrated in FIGS. 2 to 5, rod 104 includes a first end 201 projecting axially forward from gearbox 107 and a second end 200 projecting axially rearward from frame part 102. The sliding of rod 104 within gearbox 107 is actuated by personnel pushing and pulling rod end 200 relative to frame part 102.

A shaft engager is rigidly mounted at rod first end 201 and includes a circular disk 105 coaxially mounted at rod 104. Three short cylindrical plugs 106 (alternatively termed lugs or fingers) project axially from a forward facing face 202 of disk 105. Plugs 106 are evenly spaced apart in both the radial and circumferential directions relative to axis 116. Accordingly, plugs 106 extend forward from disk front face 202 whilst rod 104 extends rearwardly from a rear face 203 of disk 105. Due to the rigid coupling of disk 105 at rod 104, a rotation of rod 104 provides a corresponding rotation of plugs 106 about axis 116.

Positioning device 113 further includes a drive component configured to actuate rotational drive of rod 104 and in turn plugs 106 about axis 116. According to the specific implementation, the drive component includes a crank handle formed from a crank arm 108 that provides a radial connection between a handle 109 (provided at one end of arm 108) and a mounting boss 206 (provided at a second end of arm 108). Boss 206 is rigidly mounted at a drive shaft 205. Drive shaft 205 extends through frame part 102 via a further aperture 404. Drive shaft 205 is rotationally coupled to gearbox 107 such that rotation of shaft 205 through the internal gears of gearbox 107 provides a corresponding rotation of rod 104 about axis 116. According to the specific implementation, gearbox 107 is a reduction configuration comprising a reduction ratio of 20:1. The precise control of the rotational position of engaging plugs 106 is achievable by rotation of crank handle 109 about an axis extending through drive shaft 205. As will appreciated, gearbox 107 may comprise any internal gear configuration.

Referring to FIG. 5, device 113 is firstly mounted in position at frame 2 via mounting bracket 111 and in particular the attachment of bolts 112 to a region of crusher frame 2 below rotor shaft 6. That is, crusher frame 2, at the region of mounting of bracket 111, also includes apertures having a corresponding separation and dimension to bracket holes 103 so as to receive attachment bolts 112. With frame 100 mounted in position, rod 104 is adjusted in the horizontal plane via adjustment of attachment screws 402 within slots 403. With rod 104 aligned coaxial with rotor shaft 6, rod 104 is advanced axially along axis 116 such that engaging plugs 106 are moved towards an exposed end face 400 of rotor shaft 6. It is to be noted that the exposed end face 400 of shaft 6 is typically concealed by an end cover (not shown) secured to an annular collar 301 formed at a radially inner region of a rotor bearing assembly as indicated generally by reference 300. Rotor shaft 6 includes three corresponding bores 401 that extend axially into shaft 6 from the exposed end face 400. The radial and circumferential spacing of bores 401 correspond to the radial and circumferential positioning of engager plugs 106 such that by axially advancing rod 104 relative to frame 100, 102, plugs 106 are received within the complementary bores 401 such that disk forward face 202 is mounted in touching contact with rotor shaft end face 400.

Referring to FIG. 4, rotation of rotor shaft 6 is achieved by service personnel grasping and turning handle 109 that drives rotation of rod 104 and accordingly plugs 106 and bores 401. Device 113 therefore provides fine rotational adjustment of hammer elements 46 relative to curtain plates 20 and in particular a lower ‘toe’ region of curtains 16, 18. That is, device 113 provides an externally mounted drive apparatus to move hammer elements 46 to a minimum separation distance with curtains 16, 18 to allow accurate calibration and adjustment of the curtain setting. The present adjustment device 113 also greatly facilitates maintenance and interchange of worn hammer elements 46 by proving the convenient and reliable adjustment of the rotational position of each hammer element 46 to a top dead-centre position within chamber 10. Service personnel can then access the uppermost row of hammer elements 46 by opening the crusher pivot frame.

As will be appreciated, the present positioning device 113 is compatible for use with existing HSi crushers via releasable mounting to the region adjacent the non-driven end of rotor shaft 6 being external to the internal components of chamber 10 and the drive and gear components of crusher 1 configured to provide rotational drive of impeller 4. Once the curtain setting and/or the interchange of hammer elements 46 is complete, device 113 may then be demounted from crusher 1 and the shaft end cap (not shown) repositioned to conceal shaft end face 400. The present positioning device 113 is also compatible for use with crushers 1 having safety interlock mechanisms that encompass the safety locking and release of the shaft end cap (not shown) mounted at collar 301.

According to further specific implementations, positioning device 113 may additionally or alternatively comprise a powered motor to drive rotation of rod 104. Such a drive motor may be operated locally at frame 100 or remotely via wired or wireless electronic communications and electronic control.

Although the present embodiment(s) has been described in relation to particular aspects thereof, many other variations and modifications and other uses will become apparent to those skilled in the art. It is preferred therefore, that the present embodiment(s) be limited not by the specific disclosure herein, but only by the appended claims.

1. A rotor positioning device arranged to adjust a rotational position of a rotor of a horizontal shaft impact crusher, the positioning device comprising:
a frame;
at least one mounting provided at the frame to releasably mount the device at an external region of the crusher;
a rod rotatably mounted at the frame;
a shaft engager provided at one end of the rod to engage and an end of a shaft of the rotor so as to rotatably lock the rod and the shaft, the shaft engager being adjustably mounted relative to at least a part of the frame to enable the engager to move to and from contact with the shaft of the rotor when the frame is mounted at the crusher; and
a drive component coupled to the rod to rotate the engager and impart rotational drive to the shaft of the rotor.

2. The device as claimed in claim 1, further comprising a bearing assembly mounting the rod at the frame, the bearing assembly being arranged to allow the rod to slide axially relative to the frame to move the engager to and from contact with the shaft of the rotor.

3. The device as claimed in claim 2, wherein a second end of the rod projects rearwardly beyond the frame so as to be exposed relative to a second side of the frame, the shaft engager extending from a first side of the frame.

4. The device as claimed in claim 1, wherein the shaft engager includes a disk and a plurality of keying elements projecting from the disk and configured to be received within an end of the shaft of the rotor.

5. The device as claimed in claim 4, wherein the keying elements include plugs projecting from a first side of the disk, the rod projecting from a second side of the disk.

6. The device as claimed in claim 1, wherein the at least one mounting includes a plurality of holes provided at the frame arranged to receive attachment bolts to mount the device to the region of the crusher.

7. The device as claimed in claim 6, further comprising a plurality of bolts arranged to be received within the holes and configured to engage respective holes provided at the region of the crusher to which the device is mountable.

8. The device as claimed in claim 1, wherein the frame (100) includes a base frame carrying the at least one mounting.

9. The device as claimed in claim 8, wherein the base frame projects downwardly from a main section of the frame and has an abutment end to contact the region of the crusher to which the device is mountable.

10. The device as claimed in claim 1, wherein the shaft engager is adjustably mounted at the frame and arranged to move laterally in a sideways direction relative to the frame.

11. The device as claimed in claim 1, further comprising a crank handle coupled to the rod and configured to rotate the rod about a longitudinal axis of the rod.

12. The device as claimed in claim 11, further comprising a gearbox, the crank handle being rotatably coupled to drive rotation of the rod via the gearbox.

13. The device as claimed in claim 12, wherein the gearbox is a reduction gearbox.

14. The device as claimed in claim 13, wherein the gearbox has an overall gear ratio of 20:1.

15. A horizontal shaft impact crusher comprising:
a rotor having a shaft; and
a detachable rotor positioning device, the rotor positioning device including a frame; at least one mounting provided at the frame to releasably mount the device at an external region of the crusher; a rod rotatably mounted at the frame; a shaft engager provided at one end of the rod to engage an end of the shaft of the rotor so as to rotatably lock the rod and the shaft, the shaft engager being adjustably mounted relative to at least a part of the frame to enable the engager to move to and from contact with the shaft of the rotor when the frame is mounted at the crusher; and a drive component coupled to the rod to rotate the engager and impart rotational drive to the shaft of the rotor.
